(19) United States
(12) Patent Application Publication
(10) Pub. No.: US 2019/0307640 A1
(43) Pub. Date: Oct. 10, 2019

(54) Scratch and Sniff Cannabis Packaging

(71) Applicants: Random Vaughn, Olympia, WA (US); Jonathan Tanzer, Olympia, WA (US)

(72) Inventors: Random Vaughn, Olympia, WA (US); Jonathan Tanzer, Olympia, WA (US)

(21) Appl. No.: 15/946,681

(22) Filed: Apr. 5, 2018

(51) Int. Cl. A61J 1/00

(52) U.S. Cl. CPC A61J 1/00; A61J 2205/00

(57) ABSTRACT

The present invention relates to a method and packaging of Cannabis to help a purchaser know what kind of Cannabis is contained in the packaging. The packaging of the Cannabis includes providing an area on the exterior of the Cannabis packaging which has a scent applied form non-THC containing volatiles but mimics the scent of the Cannabis contained in the packaging. This invention then provides a method of selecting proper medical Cannabis by spelling the exterior of the packaging to know what is contained therein.

### FIELD OF THE INVENTION

The present invention relates to a method of marking Cannabis products by adding to the product container or packaging system, a scent to allow the Cannabis purchaser to smell the product without unsealing the packaging.

### DESCRIPTION OF THE RELATED ART

Several patents and patent applications have disclosed scented packaging, however when the scent is used to identify the packaged material it is done in with a scent perceptible to the human nose such as in U.S. Pat. No. 9,233,049 to Siegel. In U.S. Patent Application 20090258118 to Gillian a scented sticker is used to identify the final flavor of brewed coffee/fruit contained in the package, however this application neglects the actual scent of the product contained in the package only its brewed form, nor does it address the identification of product for medical reasons.

### BACKGROUND OF THE INVENTION

Cannabis, more commonly known as marijuana, is a genus of flowering plants that includes at least three species, Cannabis sativa, Cannabis indica, and Cannabis ruderalis as determined by plant phenotypes and secondary metabolite profiles. In practice however, Cannabis nomenclature is often used incorrectly or interchangeably. Cannabis literature can be found referring to all Cannabis varieties as “sativas” or all cannabinoid producing plants as “indicas.” Indeed the promiscuous crosses of indoor Cannabis breeding programs have made it difficult to distinguish varieties; with most Cannabis being sold in the United States having features of both sativa and indica species.

The use of Cannabis for social and medical purposes has been known for almost of all humanity's recorded history. Cannabis is most commonly administered via inhalation or consumption of marijuana-infused food and drink. However, since 1972 marijuana has been classified as a Schedule I drug under the U.S. Controlled Substances Act because the U.S. Federal Government considers it to have “no accepted medical use.” In stark contrast to this position, many U.S. states and the District of Columbia have recognized the medical benefits of Cannabis and have legalized it use for recreational purposes and medical purposes. The legalization carries may regulation such as the packaging requirements depending on the state and the purpose of sale.

President Obama has publicly commented on the recreational legalization of Cannabis in Colorado and Washington stating that “it's important for it to go forward because it's important for society not to have a situation in which a large portion of people have at one time or another broken the law and only a select few get punished”. Indeed in the same interview, President Obama remarked about Cannabis “I don't think it's more dangerous than alcohol. In fact, it is less dangerous than alcohol in terms of its impact on the individual consumer.” (Conor Friedersdorf January 2014, “Obama on Pot Legalization: ‘It's Important for it to go Forward'” The Atlantic). In line with the President's comments the U.S. Attorney General Eric Holder announced that the federal government would allow states to create a regime that would regulate and implement the legalization of Cannabis, including loosening banking restrictions for Cannabis dispensaries and growers (Jacob Sullum “Eric Holder Promises To Reassure Banks About Taking Marijuana Money ‘Very Soon’” Forbes January 2014).

In addition to these recent developments, the U.S. government has already set a precedent for patenting Cannabis, and Cannabis-related inventions. For example, U.S. Pat. No. 6,630,507 issued on Oct. 7, 2003 and assigned on the patent face to The United States of America, is directed to methods of treating diseases caused by oxidative stress by administering therapeutically effective amounts of a cannabidiol (CBD) cannabinoid from Cannabis that has substantially no binding to the N-methyl-D-aspartate (NMDA) receptor, wherein the CBD acts as an antioxidant and neuroprotectant. A search of the U.S.P.T.O Patent Application Information Retrieval (PAIR) system also reveals the existence of thousands of Cannabis related applications and issued patents including U.S. Pat. No. 8,034,843 (use of cannabinoids for treating nausea, vomiting, emesis, motion sickness), and U.S. Pat. No. 8,632,825 (anti-tumoural effects of cannabinoid combinations) among many others.

Thus, despite the official position of the U.S. Federal Government, and as recognized by the states that have legalized it, Cannabis has been shown to provide substantial benefits for medical and recreational uses. Cannabis is regularly used by a wide cross-section of society to treat a variety of maladies, conditions and symptoms including, but not limited to, the following: nausea, glaucoma, lack of appetite, mucous membrane inflammation, epilepsy, leprosy, fever, obesity, asthma, urinary tract infections, coughing, anorexia associated with weight loss in AIDS patients, pain, and multiple sclerosis.

Cannabis intoxication (i.e., euphoria, relaxation) can occur and other side effects may also accompany its use, particularly with higher doses, specific Cannabis varieties and/or over prolonged periods of usage. Undesirable side effects of using the available THC-predominant Cannabis varieties can include, but are not limited to, the following: decreased short-term memory, dry mouth, impaired visual perception and motor skills, erectile dysfunction, lower fertility, red (i.e., blood shot) eyes, increased anxiety, occasional infarction, stroke, paranoia, acute psychosis, lowered mental aptitude, hallucinations, bizarre behavior, irrational panic attacks, irrational thoughts and various other cognitive and social problems.

Some of the negative or undesirable side effects from using available Cannabis varieties for medical and recreational purposes are related to the plant's content of the chemical 49-tetrahydrocannabinol (THC). Because of Cannabis's THC content many states have strict regulations on the way Cannabis is packaged. A major hurdle to the purchase of Cannabis is the secure packaging laws of various states. Packaging can often prevent a purchaser from observing certain characteristics of the Cannabis, such as its scent.

### SUMMARY OF THE INVENTION

In view of the foregoing disadvantages inherent in selection of packaged Cannabis, the general purpose of the present invention is to provide a Cannabis package and method of selection that includes all the advantages of the secure packaging, and overcomes the drawbacks inherent therein.

Accordingly, an object of the present invention is to provide a Cannabis packages that separately contain a variety of Cannabis products each having a unique medical or recreational use.

Another object of the present invention is to provide a scented Cannabis package that encloses a Cannabis product such that the container's scent provides an easy means to smell a distinct variety of Cannabis corresponding to the Cannabis inside the package.

Another object of the present invention is packaging for Cannabis that contains a scented element and made from non-THC containing volatiles, and a corresponding method for identifying Cannabis varieties for medical or recreational purposes. The volatiles imitate the actual odor of the Cannabis contained within the package. When selecting Cannabis, the quality and medicinal properties is often determined from its scent. The scent is important selecting Cannabis for medical reasons such as seizures, headaches, or insomnia. This invention allows potential purchasers to smell the Cannabis prior to purchasing and when sealed inside packaging without exposure to any THC containing volatiles.

These together with the other aspects of the present invention, along with the various features of novelty that characterize the present invention, are pointed out with particularity in the claims and form a part of the present invention. For a better understanding of the present invention, its operating advantages, and the specified object attained by its uses, reference should be made to the accompanying drawings.

### BRIEF DESCRIPTION OF THE DRAWINGS

FIG. 1 is a packaging containing Cannabis.

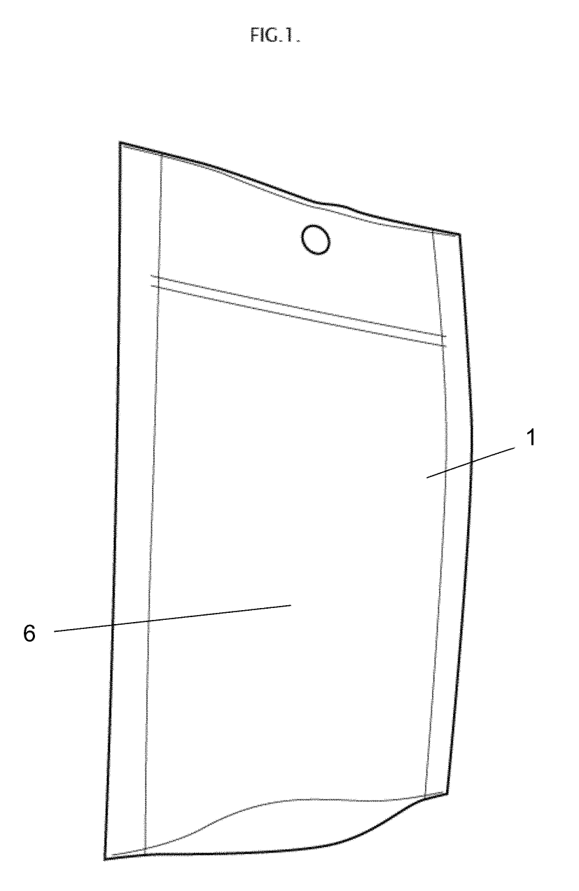

FIG. 2 is packing with a patch attached to it.

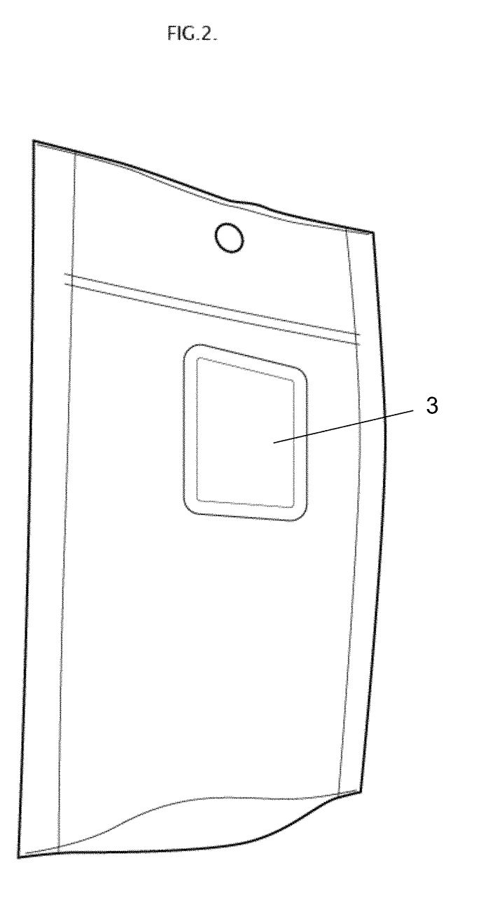

FIG. 3 is the packing and patch with the scent rising from the patch.

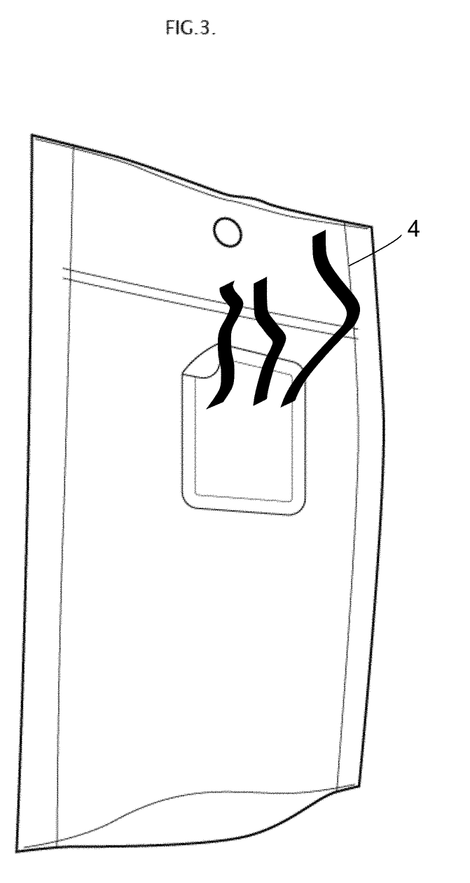

### DETAILED DESCRIPTION OF THE PREFERRED EMBODIMENT OF INVENTION

For an understanding of the present invention, reference is to be made to the following detailed description, including the claims, in connection with the above-described drawings. Although the present invention is described in connection with exemplary embodiments, the present invention is not intended to be limited to the specific forms set forth herein. It is understood that various omissions and substitutions of equivalents are contemplated as circumstances may suggest or render expedient, but these are intended to cover the application or implementation without departing from the spirit or scope of the claims of the present invention. Also, it is to be understood that the phraseology and terminology used herein is for the purpose of description and should not be regarded as limiting.

The present invention provides a Cannabis package (1) that contains a Cannabis product (6). The Cannabis product includes a solid Cannabis material (6). Generally the invention comprises childproof bottle or sealed packaging (packaging) (1) with a scent (4) either applied to the packaging (1) itself or the scent (4) is placed on the packaging with a patch or sticker (3). The scent (4) associated with the packaging is formulated to mimic the actual scent of the Cannabis (6) inside the packaging (1).

In one embodiment of the invention the scent (4) associated with the packaging (1) or patch/sticker (3) does not mimic the scent of the Cannabis contained in the package (1), but instead is a pleasant scent such as, but not limited to Freshly baked bread, Bacon, Freshly cut grass, Coffee, Cakes baking in the oven, The seaside, Freshly washed clothes, A Sunday roast, Fish and chips, Fresh flowers, A real Christmas tree, Roses, Vanilla, Scented candles, Log fires, Lavender, Lemon, Chocolate, Barbeques, Cinnamon, New car, Orange, Freshly washed hair, Coconut, Freshly cleaned house, Leather, Rain, Aftershave, Christmas cake, New books, Lime, Doughnuts, Fresh paint, Bonfires, Petrol, Matches, Sun cream, Cotton, Shampoo, Cherry, New carpets, Marzipan, Musk, Popcorn, Furniture polish, Wine, New house, Cheese, Biscuits, and many flower varieties.

One embodiment of this invention the outside of the packaging or an affixed patch or sticker is infused with a scent (4) which mimics the scent (4) of the Cannabis (6) inside the package (1) and is derived from non-THC and non-psychoactive volatiles including but not limited to limonene [1-5], α-pinene [1,3,4,6], β-pinene [1,3,4,6], β-myrcene [1,3-5], β-ocimene [2,4], β-caryophyllene [2,4-6], α-caryophyllene [4,6], α-phellandrene [4], β-carene [4], α-terpinene [4], terpinolene [4], terpineol [5], linalool [4,5], α-cadinene [4]. The volatile compounds found in Cannabis very greatly but some studies have found as many as 233 and the formulation of the scent (4) could be derived from any source without THC or psychoactive compounds. (Characterizing the Smell of Marijuana by Odor Impact of Volatile Compounds: An Application of Simultaneous Chemical and Sensory Analysis Somchai Rice, Jacek A. Koziel Published: Dec. 10, 2015 https://doi.org/10.1371/journal.pone.0144160). These chemicals can be combined to create a scent (4) that is the same or similar to the Cannabis contained inside the packaging (1).

In one embodiment the scent (4) is infused to the packaging during the package (1) manufacturing process and is thus available to the human sense of smell at all times.

In other embodiments a scent infused sticker (3) or patch (sticker) (3) is added to the packaging after the Cannabis is sealed inside.

In another embodiment the added sticker (3) could be of the type commonly known as scratch-n-sniff (3). In the scratch-n-sniff embodiment the scent (4) is infused in the sticker (3) and is not released for human sensing until there is abrasion against the sticker (3).

One embodiment of the invention is a method for selecting a Cannabis product; a consumer with previous knowledge of what Cannabis varieties help their medical ailment would enter a Cannabis distributor, review the selection of Cannabis, smelling each package (1) or scratching each package's (1) scratch-n-sniff (3) sticker to determine which variety will have the desired effect.

In another embodiment of this method invention (FIG. 4); a consumer enters a distributor and compares the package (1) scent (4) or scratch-n-sniff sticker (3) of available Cannabis to other packages (1) scent (4) to determine which of the available packages contain Cannabis with the desired effect.

I claim:

1. Packaging for Cannabis comprising;
a) scented exterior package.

2. Packaging for Cannabis comprising;
a) a scented patch of material adhered to the outside of the packaging.

3. Cannabis packaging as in claim 2 further comprising;
a) the scented patch of material is of the scratch-and-sniff type.

4. A method of marking a Cannabis product for identification through scent comprising;
a) adding as scent to the exterior of the packaging.

5. A method as in claim 4 further comprising;
a) adding the scent to the exterior of the Cannabis packaging by adhering a scented patch to the outside of the packaging.

6. A method of claim 4 further comprising;
a) adding a scent to the exterior of the Cannabis packaging by adhering a scratch-and-sniff sticker to the outside of the packaging.

7. A method of identifying a Cannabis product comprising;
a) smelling the exterior of the packaging.

8. A method as in claim 7 further comprising;
a) smelling an artificial scent added to the exterior of the packaging.

9. A method as in claim 7 further comprising;
a) scratching an artificially scented scratch-and-sniff sticker on the exterior of the Cannabis packaging and smelling the resulting scent.
